(19) United States
(12) Patent Application Publication
(10) Pub. No.: US 2014/0265829 A1
(43) Pub. Date: Sep. 18, 2014

(54) Method And Apparatus To Enhance Output Current Linearity In Tandem Electron Multipliers

(71) Applicant: EXELIS, INC., McLean, VA (US)

(72) Inventors: Joseph K. Hosea, Amherst, MA (US); Matthew L. Breuer, Hadley, MA (US); Robert A. Silverstein, Southwick, MA (US)

(73) Assignee: EXELIS, INC., McLean, VA (US)

(21) Appl. No.: 13/795,083

(22) Filed: Mar. 12, 2013

(51) Int. Cl. H01J 43/30

(52) U.S. Cl. CPC H01J 43/30
USPC 315/12.1

(57) ABSTRACT

A tandem electron multiplier device includes an input end position electron multiplier generating an electron emission; an output end position electron multiplier receiving the electron emission and generating an output electron emission; an electron collector to receive the output electron emission; a power supply; and an electrical biasing network coupled to the power supply, the electrical biasing network supplying voltages to connections at the input end position electron multiplier and the output end position electron multiplier, the voltages supplied to provide output current linearly with respect to input current across the tandem electron multiplier device.

### BACKGROUND

An electron multiplier is a device which reacts to incoming charged particles (electrons and ions), high energy photons, or energetic neutral particles by converting the input particles to secondary electrons. The secondary electrons repeatedly multiply upon collision with the wall active surface area as they travel through the channel. After this multiplication process, the electrons exit at the output end of the electron multiplier where they are collected at an electron collector (e.g., faraday cup) to yield an electrical pulse. This makes detection of the incoming charged particles, photons or neutral particles possible. The channel structure includes a resistive layer and an active surface layer to produce secondary electrons by electron-wall collision. FIG. 1 illustrates a conventional single channel electron multiplier (CEM) with an active surface layer structure and electron multiplication process as a response to an incoming positive ion. To function properly, a lower bias voltage is applied to the input end (ion input) with respect to the output end (electron output) of a single CEM. This bias voltage provides a strip current that flows through the channel resistance generating a voltage gradient along the channel to direct the secondary electron multiplication process from input to output end and providing electron replacement to the emissive surface. A vacuum environment is used to operate this device. The electron multiplier is widely used to detect ions in mass spectrometers, secondary electrons in electron microscopes, and photons using a photomultiplier tube conjoined with an electron multiplier to produce electron multiplication.

Linearity is an important electron multiplier performance criteria. Linearity is defined as the ability of the device to maintain a constant proportionality between input current and output current, or constant gain, when the device operates in analog mode. In analog mode, the gain is defined as the ratio of output current to input current. In mass spectrometer applications, the linearity performance of an electron multiplier directly impacts the accuracy of quantification of detected chemical compounds as plotted in a calibration curve.

At high output currents, two detector limitations (saturation and gain dynamic effect), prevent the electron multiplier output from being linear. Saturation is caused by electron multiplier active area wall charging and space charge, both of which prevent further electron emission from the surface. The gain dynamic effect is caused by the change of voltage distribution occurring along the electron multiplier channel when operating at high current levels. At low output current operation, the effect is negligible for most applications. The observed effect of the gain dynamic is a gain increase/decrease at higher current which in turn increases/decreases the output current; therefore the relationship between input current and output current is no longer linear.

### SUMMARY

An exemplary embodiment is tandem electron multiplier device includes an input end position electron multiplier generating an electron emission; an output end position electron multiplier receiving the electron emission and generating an output electron emission; an electron collector to receive the output electron emission; a power supply; and an electrical biasing network coupled to the power supply, the electrical biasing network supplying voltages to connections at the input end position electron multiplier and the output end position electron multiplier, the voltages supplied to provide output current linearly with respect to input current across the tandem electron multiplier device.

Other aspects, features, and techniques of embodiments of the invention will become more apparent from the following description taken in conjunction with the drawings.

### BRIEF DESCRIPTION OF THE DRAWINGS

Referring now to the drawings wherein like elements are numbered alike in the Figures:

FIG. 1 depicts a conventional channel electron multiplier and channel active area having a resistive layer and emissive layer on the top of the resistive layer;

FIGS. 2A-2C depict conventional tandem CEM configurations;

FIG. 3 is a schematic diagram of tandem CEM device using an electrical biasing network to enhance output linearity;

FIG. 4 depicts an extension of the device shown in FIG. 3 utilizing additional CEM elements in a tandem configuration;

FIGS. 5A-5D depict an electrical biasing network applied to discrete dynode electron multipliers, and the combination of CEM and discrete dynode electron multipliers;

FIG. 6 depicts a tandem CEM device to enhance linearity with an electrical biasing network constructed from resistive components;

FIG. 7 is a plot of a bias voltage change rate for an input end position and an output end position of a CEM;

FIG. 8 is a plot of input current versus output current for a triple channel output end position CEM employing a resistive electrical biasing network with two device gain settings applied;

FIG. 9 is a plot of input current versus output current for a conventional triple channel output end position CEM with two device gain settings applied;

FIG. 10 depicts a tandem CEM having a single channel input end position CEM and a triple channel output end position CEM with an electrical biasing network constructed from passive and active electrical components;

FIG. 11 is a plot of bias voltage change rate for the input end position and output end position of a CEM with respect to power supply output using an electrical biasing network of FIG. 10; and

FIG. 12 is a plot of input current versus output current for a triple channel output end position CEM biased using an electrical biasing network constructed from passive and active electrical components with two device gain settings applied.

### DETAILED DESCRIPTION

FIGS. 2A-2C show exemplary tandem CEMs that may be used with embodiments of the invention. The tandem CEMs are described in further detail in U.S. Pat. No. 7,687,978, the entire contents of which are incorporated herein by reference. The tandem CEMs may include an input end position CEM 10 having a single channel and an output end position CEM 20 having multiple (e.g., 3) channels. An incoming beam of charged particles is received at a funnel (not shown) and triggers an electron avalanche along the input end position CEM 10. The electron emission from the input end position CEM 10 is received at the multiple channels of the output end position CEM 20. The output electron emission of the output end position CEM 20 is collected at an electron collector (e.g., Faraday cup) 40. As shown in FIG. 2C, additional stages of CEMs may be used, including a further multi-channel CEM 21.

FIG. 3 is a schematic diagram of an electron multiplier device having a tandem CEM and an electrical biasing network to enhance output linearity. The tandem CEM includes an input end position CEM 10 (e.g., single channel), output end position CEM 20 (e.g., multi-channel) and a faraday cup 40. An electrical biasing network 50 provides a biasing voltage distribution on input end position CEM 10, output end position CEM 20 and the faraday cup 40 via electrical connections 31, 32 and 33 on the input end position CEM 10 and output end position CEM 20. The electrical biasing network 50 is powered by power supply 60.

The electrical biasing network 50 maintains a constant voltage at electrical connection 32 between input end position CEM 10 and output end position CEM 20 during operation, but the voltage at electrical connection 32 can be adjusted during gain adjustment via power supply 60. Power supply 60 may be located outside a vacuum chamber where the electron multiplier is operating. Power supply 60 provides a biasing voltage at electrical connection 31 and also provides strip current to input end position CEM 10 and/or output end position CEM 20. Electrical biasing network 50 controls voltage distribution between input end position CEM 10 and output end position CEM 20 and voltage at the back end of output end position CEM 20, if necessary, to generate a lower electrical potential with respect to faraday cup 40 for high efficiency electron collection.

High output current linearity in the tandem CEM is achieved by fabricating CEM 20 with low channel resistance to minimize the gain dynamics effect. The electrical biasing network 50 is selected such that the bias voltage rate change on input end position CEM 10 is higher to control the overall gain of the device, and the voltage rate change on output end position CEM 20 is adequate to compensate for gain aging of the output end position CEM 20. In this case, input end position CEM 10 is set to operate in the linear regime and output end position CEM 20 controls the linearity for high output current operation. With this arrangement, the strip current on output end position CEM 20 weakly depends on the overall tandem CEM gain, thereby eliminating the gain strip current dependency.

Incoming input current at input end position CEM 10 is multiplied through electron multiplication. Input end position CEM 10 outputs electrons that are multiplied further by output end position CEM 20, which then delivers linear high output current to the faraday cup 40. This configuration reduces joule heating from the overall electron multiplier, since heat is only generated at output end position CEM 20. Output end position CEM 20 can be constructed with a multiple channel configuration using a channel substrate having high heat conduction; this reduces the heat from the channel active area. Additional CEM elements can be added, as shown in FIG. 4, where additional OEMs 21, 22 up to 2N are shown. The electrical biasing network 50 is connected to the CEMS at connections 31, 32, 33, 3N. The same biasing voltage technique as discussed with reference to FIG. 3 is applied to the configuration of FIG. 4 to enhance the output current linearity with respect to input current.

FIG. 5A depicts application of an electrical biasing network 50 to a discrete dynode electron multiplier to achieve high output current linearity. Electrical biasing network 50 may include a plurality of passive components (e.g., resistors, capacitors) to distribute voltage along the discrete dynode electron multiplier to achieve high output current linearity. FIG. 5B depicts how a first section of the discrete dynode electron multiplier may be biased for gain control and a second section of the discrete dynode electron multiplier may be biased for output current intensity control. FIG. 5C depicts use of an electrical biasing network 50 with a CEM and discrete dynode electron multiplier. The resistor values of the electrical biasing network 50 are selected to provide high output current linearity. FIG. 5D depicts use of an electrical biasing network 50 with a series of discrete dynode electron multipliers. The electrical biasing network 50 provides high output current linearity.

In FIGS. 5A-5D, the resistor values of the electrical biasing network 50 are selected to bias the dynodes to provide high output current linearity. In practice, a group of dynodes in the chain can collectively function as the gain controller and another group of dynodes can function as the output current intensity controller. Alternatively, individual discrete dynode electron multipliers in tandem, or a combination of CEM and discrete dynode electron multipliers in tandem, also can be used, as shown in FIGS. 5A-5D.

FIG. 6 illustrates an electrical biasing network 50 having two resistors 51 and 52, which is a realization of a basic electrical biasing network 50. The values of resistors 51 and 52 are set lower than the resistance of the input end position CEM 10 and output end position CEM 20, so that the bias voltage at connection 32 holds steady and is controlled by the resistive divider. Since output end position CEM 20 requires a low resistance value to avoid any gain dynamic effect, resistor 52 is set at typically about 10 times lower than the resistance of the output end position CEM 20 channel. Resistor 51 is chosen to set a voltage rate of change on input end position CEM 10 higher than a voltage rate of change on output end position CEM 20 in order to control the overall device gain. However, the value of resistor 51 still meets the condition for the voltage divider to fix the voltage at connection 32. In this exemplary configuration, the power supply 60 is able to provide high current, on the order of mA, to the resistive network, which current is normally 10 times higher than the strip current to flow through output end position CEM 20.

The voltage distribution change as a function of total bias voltage power supply 60 is shown in FIG. 7. FIG. 7 is a plot of a bias voltage change rate for an input end position CEM and an output end position CEM with respect to power supply output using an electrical biasing network 50 constructed from resistive elements. The bias voltage change rate for the input end position CEM is higher (i.e., steeper sloped) and is intended to control the gain of the device. On the other hand, the bias voltage change rate on the output end position CEM is lower (i.e., flatter slopes) and is intended to compensate for gain degradation due to aging. In other words, the voltage distribution between the input end position CEM and output end position CEM is such that an increase in voltage from the power supply 60 causes a larger voltage adjustment at the input end position CEM 10 than at the output end position CEM 20. The weaker voltage adjustment on the output end position CEM 20 compensates for gain degradation as the output end position CEM 20 ages.

FIG. 8 is a plot of input current versus output current for a tandem CEM having a single channel input end position CEM and a triple channel output end position CEM. The electrical biasing network 50 employs a resistive network. Plots 100 and 200 correspond to the output end position CEM output current at two different gain settings. As shown in FIG. 8, the output current of the output end position CEM is linear up to a current of 60 uA, and above 60 uA.

By way of comparison, FIG. 9 is a plot of input current versus output current for a conventional tandem CEM having a single channel input end position CEM and a triple channel output end position CEM, without an electrical biasing network. Plots 102 and 202 correspond to the output end position CEM output current at two different gain settings. FIG. 9 shows the linearity of input current versus output current up to 25 uA. Beyond 25 uA, the device output current is non-linear due to gain decrease.

FIG. 10 illustrates an exemplary electrical biasing network 50 including active electrical components and passive electrical components. The active electrical component 55, such as a MOSFET or bipolar transistor, stabilizes the voltage at connection 32 between input end position CEM 10 and output end position CEM 20 at a value determined by power supply 60 voltage and the ratio of resistors 52 and 53. The operation of resistor 52 is that of a current source, which shunts the current in input end position CEM 10 and output end position CEM 20. If the current changes through input end position CEM 10 and output end position CEM 20, the voltage at connection 32 will change. This change will adjust the current through active electrical component 55 so as to drive the voltage at connection 32 back to the value determined by resistors 52 and 53. During the device operation, input end position CEM 10 and output end position CEM 20 bias voltages are fixed. The gain dynamic effect is reduced by fabricating a low channel resistance output end position CEM 20, and gain-strip current dependency can be eliminated by adjusting the ratio of resistors 52 and 53, so that the bias voltage on input end position CEM 10 controls the gain of the device and the bias voltage on output end position CEM 20 compensates for gain during aging. The electrical biasing network 50 of FIG. 10 does not require as high a current supply output as that required in the electrical biasing network illustrated in FIG. 6, since the active component 55 is able to regulate the voltage at connection 32.

FIG. 11 is a plot of bias voltage change rate for the input end position and output end position of a tandem CEM with respect to power supply output using an electrical biasing network of FIG. 10. The bias voltage change rate for the input end position CEM 10 is higher and intended to control the gain of the device. On the other hand, the bias voltage change rate on the output end position CEM 20 is lower and intended to compensate for gain degradation due to aging.

FIG. 12 is a plot of input current versus output current for an electron multiplier having a single channel input end position CEM 10 and a triple channel output end position CEM 20. The device is biased using an electrical biasing network constructed from passive and active electrical components, such as that in FIG. 10. Plots 103 and 203 correspond to the output end position CEM output current at two different gain settings. Note that the current is linear to 60 uA and above 60 uA.

Embodiments provide an electrical biasing network across a tandem electron multiplier to improve linearity in each individual stage of the electron multiplier. The electrical biasing network, constructed from passive and/or active electrical components, is applied to operate the input end position CEM and output end position CEM properly by controlling the bias voltages so that the two CEMs function as intended to achieve linear high output current. The electrical biasing network may be designed so that a change in the biasing of the input end position CEM controls the overall gain of the device and the change in biasing of the output end position CEM controls the linear output current intensity and restores or compensates for gain degradation due to normal aging. Tandem CEM devices in accordance with embodiments of the invention experience less joule heating, since the heating is generated at the output end position CEM only.

Exemplary embodiments described herein relate to tandem CEM electron multipliers and tandem discrete dynode electron multipliers. It is understood that the electrical biasing network, (with passive and/or active components) may be applied to a variety of tandem electron multipliers, include CEM electron multipliers, discrete dynode electron multipliers, micro channel plate (MCP) electron multipliers, micro-sphere plate (MSP) electron multipliers, etc., arranged in tandem configurations. The stages of the tandem electron multiplier may use similar (e.g., input end position CEM and output end position CEM) or different constructions (e.g., input end position CEM and output end position discrete dynode) and as such, embodiments are not limited to specific electron multiplier types.

The terminology used herein is for the purpose of describing particular embodiments only and is not intended to be limiting of the invention. While the description of the present invention has been presented for purposes of illustration and description, it is not intended to be exhaustive or limited to the invention in the form disclosed. Many modifications, variations, alterations, substitutions, or equivalent arrangement not hereto described will be apparent to those of ordinary skill in the art without departing from the scope and spirit of the invention. Additionally, while the various embodiments of the invention have been described, it is to be understood that aspects of the invention may include only some of the described embodiments. Accordingly, the invention is not to be seen as being limited by the foregoing description, but is only limited by the scope of the appended claims.

What is claimed is:

1. A tandem electron multiplier device comprising:
an input end position electron multiplier generating an electron emission;
an output end position electron multiplier receiving the electron emission and generating an output electron emission;
an electron collector to receive the output electron emission;
a power supply; and
an electrical biasing network coupled to the power supply, the electrical biasing network supplying voltages to connections at the input end position electron multiplier and the output end position electron multiplier, the voltages supplied to provide output current linearly with respect to input current across the tandem electron multiplier device.

2. The tandem electron multiplier device of claim 1 wherein:
the electrical biasing network supplies the voltages such that the input end position electron multiplier provides gain adjustment and current linearity and the output end position electron multiplier reduces gain dynamic effects to control linear high output current.

3. The tandem electron multiplier device of claim 2 wherein:
the electrical biasing network supplies the voltages to bias a voltage distribution between the input end position electron multiplier and output end position electron multiplier.

4. The tandem electron multiplier device of claim 3 wherein:
the voltage distribution between the input end position electron multiplier and output end position electron multiplier is such that an increase in voltage from the power supply causes a larger voltage adjustment at the input end position electron multiplier than at the output end position electron multiplier.

5. The tandem electron multiplier device of claim 1 wherein:
the electrical biasing network includes at least two passive electrical elements.

6. The tandem electron multiplier device of claim 5 wherein:
the passive electrical elements include at least one of a resistor and a capacitor.

7. The tandem electron multiplier device of claim 1 wherein:
the electrical biasing network includes an active electrical element.

8. The tandem electron multiplier device of claim 7 wherein:
the active electrical element includes a transistor.

9. The tandem electron multiplier device of claim 1 wherein:
the output end position electron multiplier has a multi-channel configuration.

10. The tandem electron multiplier device of claim 1 wherein:
the electrical biasing network supplies the voltages such that the input end position electron multiplier functions as a gain controller and the output end position electron multiplier functions as an output intensity controller.

11. The tandem electron multiplier device of claim 1 wherein:
the input end position electron multiplier includes a group of dynodes to function as a gain controller and the output end position electron multiplier includes another group of dynodes to function as an output intensity controller.

12. The tandem electron multiplier device of claim 1 wherein:
the input end position electron multiplier includes a discrete dynode electron multiplier and the output end position electron multiplier includes a discrete dynode electron multiplier

13. The tandem electron multiplier device of claim 1 wherein:
the input end position electron multiplier includes a channel electron multiplier and the output end position electron multiplier includes a discrete dynode electron multiplier.

14. The tandem electron multiplier device of claim 13 wherein:
the input end position electron multiplier is one of a channel electron multiplier, discrete dynode electron multiplier, micro channel plate electron multiplier and micro sphere plate electron multiplier.

15. The tandem electron multiplier device of claim 14 wherein:
the output end position electron multiplier is one of a channel electron multiplier, discrete dynode electron multiplier, micro channel plate electron multiplier and micro sphere plate electron multiplier.

16. The tandem electron multiplier device of claim 1 wherein:
an output current of the output end position electron multiplier is linear up to and above 60 uA.
